(19) United States
(12) Patent Application Publication
(10) Pub. No.: US 2026/0236671 A1
(43) Pub. Date: Aug. 13, 2026

(54) REAL TIME MACHINE LEARNING FOR GUIDED DOCUMENT ANNOTATIONS

(71) Applicant: HYPER LABS, INC. d/b/a HYPERSCIENCE, New York, NY (US)

(72) Inventors: Jocelyn BEAUCHESNE, Brooklyn, NY (US); Pushkar JAIN, Dallas, TX (US); Johan EDVINSSON, Austin, TX (US); Akhil LOHCHAB, Brooklyn, NY (US)

(73) Assignee: HYPER LABS, INC. d/b/a HYPERSCIENCE, New York, NY (US)

(21) Appl. No.: 19/638,919

(22) Filed: Apr. 3, 2026

Related U.S. Application Data
(63) Continuation of application No. PCT/US2024/048506, filed on Sep. 26, 2024.
(60) Provisional application No. 63/542,427, filed on Oct. 4, 2023.

(51) Int. Cl. G06F 40/169; G06F 16/35; G06N 20/00

(52) U.S. Cl. CPC G06F 40/169; G06F 16/35; G06N 20/00

(57) ABSTRACT

A method for annotating documents. When a new document is received from an external device, the new document is analyzed to determine a group of documents that the new document is most similar to. Once the group of documents is determined on or more trained machined learning models that have been trained on previous documents associated with the group of documents are retrieved and used to analyze the new document. Based on the analysis the one or more trained machine learning models produce one or more annotation suggestions and present these to a user; the user may then provide one or more corrections, which are then used along with one or more validated annotation suggestions to annotate the new document as well as update the one or more trained machine learning models.

### CROSS-REFERENCE TO RELATED APPLICATIONS

This application is a continuation of International Patent Application No. PCT/US 2024/048506, filed on Sep. 26, 2024, which claims the benefit of priority to U.S. Provisional Application No. 63/542,427, filed on Oct. 4, 2023, the contents of each of which are incorporated herein by reference in their entireties, and to each of which priority is claimed.

### TECHNICAL FIELD

This disclosure generally relates to computer-implemented natural language processing of documents. The disclosure more specifically relates to using real time machine learning for guided document annotations.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Providing annotations to one or more documents is often useful. Annotations allow for easier review of documents, helping to uncover patterns, notice important words, make editing easier, and/or identify other important information. Annotations allow the end users not to waste time or resources reviewing contents of documents that do not need to be reviewed by the end users.

Currently, annotations are generally performed using a manual process. However, as the number of documents increases, the accuracy and/or consistency of the manual annotations often decreases. Further, manually providing the annotations may be a time-consuming process that may result in end users of the documents not receiving the annotated document in a sufficiently prompt manner. Based on the foregoing, there is an acute need in the relevant technical fields for a computer-implemented, high-speed system and method for automatically annotating documents in real time.

### SUMMARY OF PARTICULAR EMBODIMENTS

The embodiments disclosed herein are only examples, and the scope of this disclosure is not limited to them. Particular embodiments may include all, some, or none of the components, elements, features, functions, operations, or steps of the embodiments disclosed herein. Embodiments of the disclosure are particularly disclosed in the attached claims directed to a method, a storage medium, a system, and a computer program product, wherein any feature mentioned in one claim category, e.g., method, may be claimed in another claim category, e.g., system, as well. The dependencies in the attached claims are chosen for formal reasons only. However, any subject matter resulting from a deliberate reference back to any previous claims, in particular multiple dependencies, may be claimed so that any combination of claims and the features thereof are disclosed and may be claimed regardless of the dependencies chosen in the attached claims. The subject matter which may be claimed comprises not only the combinations of features as set out in the attached claims but also any other combination of features in the claims, wherein each feature mentioned in the claims may be combined with any other feature or combination of other features in the claims. Furthermore, any of the embodiments and features described or depicted herein may be claimed in a separate claim, in any combination with any embodiment, feature described, depicted herein, or with any of the features of the attached claims.

The present disclosure provides a technical solution to the technical problems discussed above by providing a system and method with the capability to automatically annotate documents in real time. The method allows for similar documents to be grouped, and using a trained machine learning model, annotations may be provided to the documents. The trained machine learning model is trained in real time as a user annotates documents. The model needs little or no initial training data and develops over time as it is used with real documents. As more documents are annotated, the trained machine-learning model may receive feedback and provide more accurate annotations. Annotations form the training data used to train machine learning models so that the model may then identify the data points. By using this solution, the documents may be quickly and accurately annotated, decreasing the need for manual annotations. The solution also allows for easy development of the model to perform automatic annotations without the need for producing or obtaining a large amount of training data, allowing it to be used, for example, on relatively obscure documents or without exposing confidential information.

In at least one embodiment, the disclosed system and method annotate documents. When a new document is received from an external device, the new document is analyzed to determine a group of documents that the new document is most similar to. Once the group of documents is determined, one or more trained machined learning models that have been trained on previous documents associated with the group of documents are retrieved and used to analyze the new document. Based on the analysis the one or more trained machine learning models produce one or more annotation suggestions and present these to a user. The user may then provide one or more corrections, which are then used along with one or more validated annotation suggestions to annotate the new document as well as update the one or more trained machine learning models.

### BRIEF DESCRIPTION OF THE DRAWINGS

FIG. 1 illustrates a system for performing annotations in accordance with one or more embodiments.

FIG. 2 illustrates a suggester operation in accordance with one or more embodiments.

FIG. 3 illustrates a method for annotating documents in accordance with one or more embodiments.

FIG. 4 illustrates an exemplary document being annotated in accordance with one or more embodiments.

FIG. 5 illustrates a computer system with which one or more embodiments may be implemented.

### DESCRIPTION OF EXAMPLE EMBODIMENTS

In the following description, numerous specific details are set forth in order to provide a thorough understanding of the present disclosure for the purposes of explanation. It will be apparent, however, that the present disclosure may be practiced without these specific details. In other instances, well-known structures and devices are shown in block diagram form in order to avoid unnecessarily obscuring the present disclosure.

The text of this disclosure, in combination with the drawing figures, is intended to state in prose the algorithms that are necessary to program the computer to implement the claims at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the claims herein.

Embodiments are described in the sections below according to the following outline:
1. General Overview
2. Structural & Functional Overview
2.1 System Configured to Perform Annotations
2.2 Details of a Suggester
2.3 Method of Annotating Documents
2.4 Example Annotated Document
3. Implementation Example-Hardware Overview

### 1. General Overview

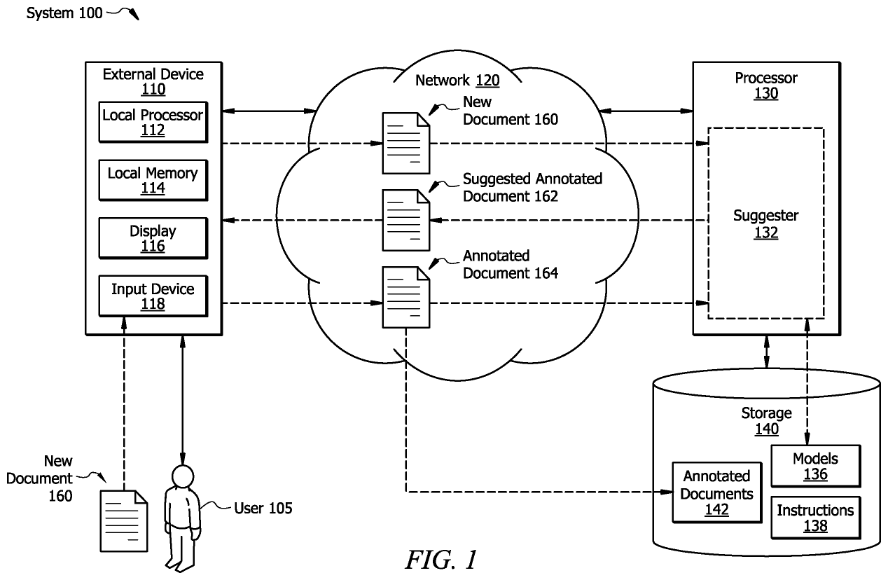

A system and method for performing annotation of documents using machine learning according to some embodiments of the present disclosure will be described with reference to FIGS. 1-5. The workflow of this method comprises at least three steps: (1) clustering documents, (2) training a machine learning model for annotation, and (3) detecting anomalously annotated documents.

In some embodiments, the step of clustering documents generates a desired group of similar documents for annotation. The step of clustering documents for generating the desired documents includes but is not limited to a retrieving method that retrieves a group of documents; a clustering algorithm to compare the similarity between each document of the retrieved group of documents by extracting and comparing word locations or other information contained in each document; and a community detection algorithm to generate a desired cluster of similar documents from the retrieved group of documents.

In some embodiments, the step of training the machine learning models generates a predicted annotation on a new document. The step of training a machine learning model for generating the predicted annotation includes but is not limited to generating a predicted field of annotation and a manual annotation process that involves reviewing, correcting, and validating the predicted field of annotation by one or more annotators or users, and generating feedback to the machine learning models to train the machine learning models.

In some embodiments, the step of detecting anomalously annotated documents generates a selected group of annotated documents from the desired group of documents by removing any anomalously annotated documents. The step of detecting anomalously annotated documents includes but is not limited to an automatic comparing algorithm that compares each of the annotated documents to find out which documents are annotated differently from the others and a selection process that removes anomalous documents. The selected documents may be further fed into a Deep flex training algorithm for deep learning training.

### 2. Structural & Functional Overview

### 2.1 System Configured to Perform Annotations

FIG. 1 illustrates a distributed computer system 100, showing the context of use and principal functional elements with which one embodiment could be implemented. In an embodiment, computer system 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem. The inventors disclaim the right or intent to cover any judicial exception to patent eligibility, such as an abstract idea, mental process, method of organizing human activity, or mathematical algorithm. Any interpretation of the disclosure or claims to cover any judicial exception to patent eligibility, such as an abstract idea, mental process, method of organizing human activity, or mathematical algorithm, has no support in this disclosure and is erroneous.

In one embodiment, an exemplary system for annotating a new document 160 consisting of one or more pages is illustrated in FIG. 1. Specifically, a new document 160 from the group of similar documents is input from an external device 110 into a processor 130, which performs a suggester operation 132 that generates multiple suggested fields. One or more users 105 or annotators review the suggested fields in the documents, reject or correct the fields that are not covering a desired field, annotate the fields that are missing, and approve or validate the fields that are covering the desired field, and finally input feedback that is used to form an annotated document 164 by the processor 130. In one embodiment, a single document may additionally be randomly selected from the group of clustered documents and reviewed by a user 105 or an automated process for validity in order to further improve the suggester operation 132 and/or maintain accuracy and performance.

In the example of FIG. 1, an external device 110 receives a new document 160. The new document 160 is then communicated through a network 120 to a processor 130 that performs a suggester operation 132. The processor 130 performs one or more operations, such as the suggester operation 132, using the instructions 138 stored in storage 140 to both annotate the new document 160 and train one or more machine learning models 136. For purposes of illustrating a clear example, a single external device 110, network 120, processor 130, and storage 140 are shown in FIG. 1. Still, practical embodiments may include thousands to millions of computing devices distributed over a wide geographic area or over the globe, and hundreds to thousands of instances of processor 130 to serve requests and computing requirements of the external device(s) 110. The system 100 may be configured as shown or in any other suitable configuration and may include more or less components then are shown in FIG. 1.

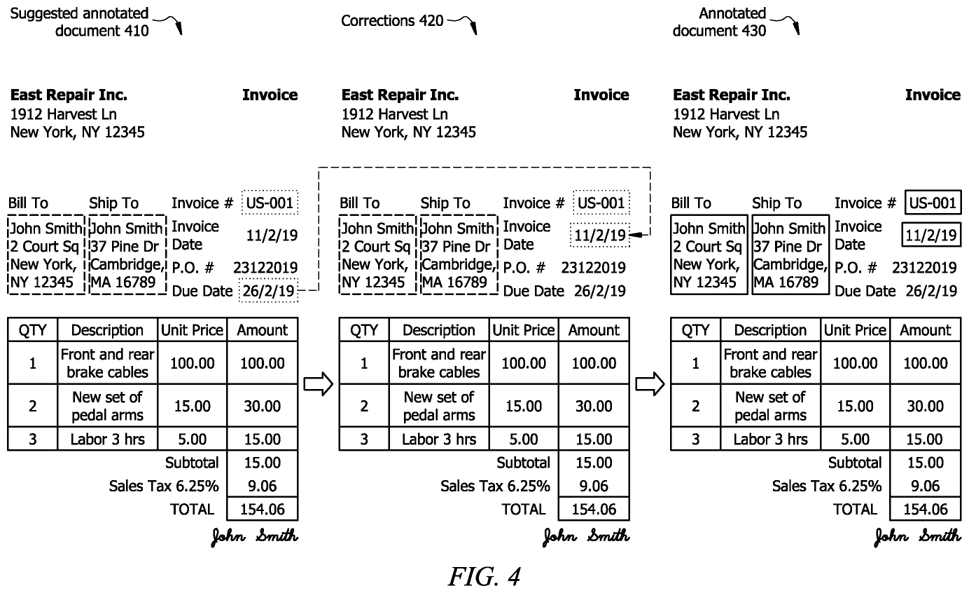

The new document 160 may be any type of document that needs annotating. An exemplary new document 410 is shown in FIG. 4, as will be described below. The new document 160 may be an invoice, a memo, an order form, a letter, or any other kind of written document that a user 105 desires to have annotated by the processor 130. The document may be a physical document, which is then scanned in by the external device using its input device 118. Alternatively, or in addition, the new document 160 may be an electronic file such as an email, a word processing document, a PDF, or another electronic document format. The disclosure is not limited to the various formats and types of documents described above, and the new document 160 may take any form.

The external device 110 may include but is not limited to, computers, laptops, mobile devices (e.g., smartphones or tablets), kiosks, multi-function machines, scanners, or any other suitable type of device that may receive a new document 160, allow a user 105 to approve or disapprove annotations on a suggested annotated document 162, and annotate a new document 160 to form an annotated document 164. The external device 110 may be associated with more than one user 105 and may be a shared device. The external device 110 includes at least one local processor 112 that performs one or more processes or operations, including but not limited to sending the new document 160 through the network to the processor 130, receiving annotations from a user 105, and allowing a user 105 to approve or disapprove suggested annotations in a suggested annotated document 162 received from the processor 130 through the network 120. The external device 110 also includes a display 116, which may display the suggested annotated document 162, and a graphical user interface (GUI), which may allow a user to annotate documents and provide feedback to the processor 130. The external device also includes an input and output device 118 to receive inputs from the user 105 and receive new documents 160.

The external device 110 may also include at least one local memory 114 for storing instructions as well as any data related to either the new document 160, other operations, or applications performed by the external device 110. The local memory 114 causes the local processor 112 to receive the new document 160 and send it through the network 120 to the processor 130. The local processor 112 then receives a suggested annotated document 162 from the processor 130. This suggested annotated document 162 may then be reviewed by the user 105 for accuracy so that the user 105 may approve the suggested annotations, disapprove the suggested annotations, or make changes to the suggested annotations, resulting in an annotated document 164. The annotated document 164 is then sent by the local processor 112 through the network back to the processor 130, which uses the annotated document 164 to update or provide feedback to the one or more trained machine learning models 136 and to store the document in the storage 140 along with any other similar documents in the annotated documents 142.

The network 120 may be any suitable type or combination of wireless or wired networks including, but not limited to, all or a portion of the Internet, an intranet, a private network, a public network, a peer-to-peer network, the public switched telephone network, a cellular network, a local area network (LAN), a metropolitan area network (MAN), a wide area network (WAN), and a satellite network. The network 120 may be configured to support any suitable type of communication protocol as would be appreciated by one of ordinary skill in the art.

The processor 130 receives and processes the new document 160. The processor 130 then prepares the suggested annotated document 162. The processor 130 may take the form of any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 130 may be a programmable logic device, a microcontroller, a microprocessor, or any suitable combination of the preceding. The processor 130 is communicatively coupled to and in signal communication with the storage 140. The one or more processors making up the processor 130 are configured to process data and may be implemented in hardware or software. For example, the processor 130 may be 8-bit, 16-bit, 32-bit, 64-bit, or of any other suitable architecture. The processor 130 may include an arithmetic logic unit (ALU) for performing arithmetic and logic operations, processor registers that supply operands to the ALU and store the results of ALU operations, and a control unit that fetches instructions 138 from storage 140 and executes them by directing the coordinated operations of the ALU, registers and other components.

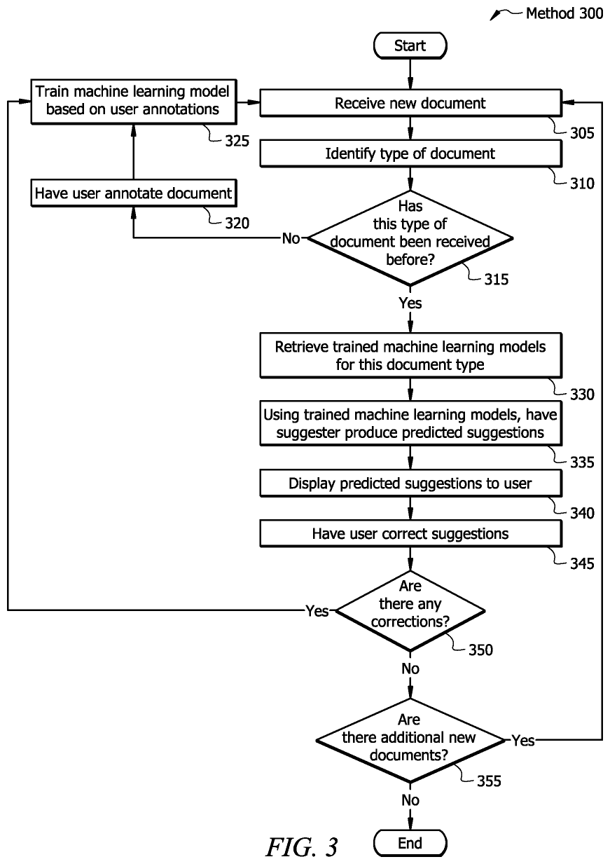

The processor 130 is in operative communication with the storage 140. The processor 130 is configured to implement various instructions 138 stored in the storage 140. The processor 130 may be a special purpose computer designed to implement the instructions 138 and functions disclosed herein. For example, the processor 130 may be configured to perform the operations described in FIG. 3.

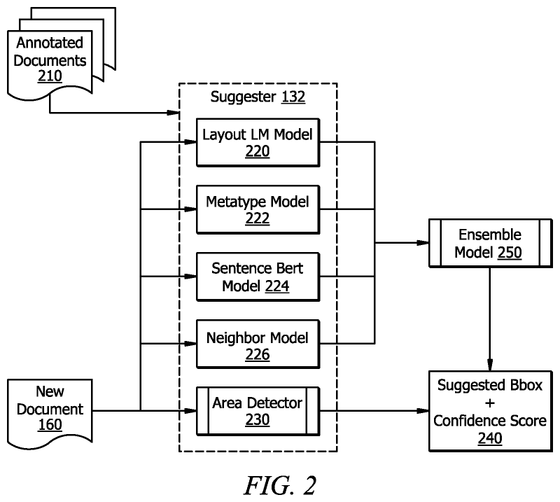

Additionally, the processor 130 executes instructions 138 to perform a series of one or more operations such as, but not limited to, a suggester operation 132, which is described in more detail below with regards to FIG. 2 and the method of FIG. 3. The processor 130 receives the new document 160 from the external device 110 through the network 120. The processor 130 then determines a group or type of documents to which the new document is most similar. The processor 130 may determine the group or type by using a clustering algorithm that compares the new document 160 or parts of the new document 160 with annotated documents 142 in storage 140. This may involve analyzing word location or identifying similar words.

Once the processor 130 determines the group of documents or type of documents the new document 160 belongs to, or the processor 130 determines that the new document 160 does not belong to any groups that are found in the annotated documents 142 the processor 130 then performs the suggester operation 132 on the new document 160 to produce a suggested annotated document 162. The user 105 or other process provides feedback and updates the suggested annotated document 162 and returns an annotated document 164 to the processor 130.

When it is determined that the new document 160 does not belong to any previous groups or has not been encountered before, the processor 130 causes the external device 110 to have the user 105 manually provide annotations to the new document 160. The resulting annotated document 164 is then used by the processor 130 to begin training new machine learning models 136 associated with the new document type. In one embodiment, only the first instance of a new type of document causes the processor 130 to cause the external device 110 to have the user 105 manually provide annotations to the new document 160; however, in other embodiments, additional instances such as the first three, first five, or first ten cause the external device 110 to have the user 105 to manually provide annotations to the new document 160.

When the document belongs to a group of documents that are stored in the annotated documents 142, the processor performing the suggester operation 132 retrieves one or more machine learning models 136 from the storage 140 that have been trained on other documents from the group of documents. In one or more embodiments, multiple machine learning models 136 are applied in multiple steps. Each machine learning model 136 identifies one or more segments or extracted bonding box (bbox) regions. A bbox region is a rectangular or square-shaped region that is defined by two sets of coordinates: one specifying the position of the top-left corner of the box and the other specifying the position of the bottom-right corner of the box. This rectangular region is used to enclose and define the boundaries of an object or region of interest within an image or a two-dimensional space of a document.

In one or more embodiments, the processor 130 performing the suggester operation 132, then has each machine learning model apply a numerical ranking to each of the segments or bbox of the new document 160. These numerical rankings are then averaged to determine a level of confidence for each segment or bbox. When the ranking is higher than a predetermined threshold, the segment or bbox is highlighted or indicated in another manner and then added to the suggested annotated document 162 by the processor 130. This predetermined threshold may be chosen by the user 105, administrator, developer, or other concerned party. It may also be learned by one or machine learning models based on user preference and the avoidance of false positives. This is then sent back to the external device 110 so that a user 105 may provide feedback. The suggested annotated document 162 is then sent back to the external device 110 so that the user may provide feedback and produce an annotated document 164 with the correct annotations.

Once the annotated document 164 and any feedback is received from the external device, the one or more machine learning models 136 used by the processor 130 to perform the suggester operation 132 may then be updated using the annotated document 164 and any user 105 feedback.

In some embodiments, the number of annotated documents 142 for training the machine learning models 136 may range from one to five, preferably from three to five, depending on the number of designated fields for annotating each document. The more designated fields for annotating each document, the more annotated documents 142 will be required to input for training the machine learning models 136. The number and location of the fields to be annotated are pre-determined by a user.

In some embodiments, the manual annotation by the user 105 providing annotated document 164 is concurrently running with the training of the one or more machine learning models 136. The suggester operation 132 keeps generating suggested annotated document 162, while the one or more users 105 or annotators manually correct and validate the previous annotated documents 142, new documents 160, and suggested annotated documents 162. The one or more users 105 do not have to annotate all the documents. The limit of manual annotation is set by a configuration option and made based on a user 105, administrator, or developer's preferences as well as the capabilities of the specific device or processor 130 performing the suggester operation 132 and the type of new document 160 being annotated.

The processor 130 may perform more or less operations than shown in FIG. 1, and the specific suggester operation 132 shown is only an example. While a single processor 130 is shown, the processor 130 may include a plurality of processors or computational devices. The operations described herein as being performed by the processor 130 may be performed by a separate processor or software application executed on a single computational device, e.g., processor 130, or they may be located on separate servers or even separate data centers such as a cloud server.

Storage 140 may be any type of storage or memory for storing a computer program comprising instructions 138, trained machine learning models 136, and annotated documents 142. The storage 140 may be a non-transitory computer-readable medium that is in operative communication with the processor 130. Alternatively, or additionally the storage 140 may be a separate device that communicates with the processor 130 over the network 120. The storage 140 may be one or more disks, tape drives, or solid-state drives. Alternatively, or in addition, the storage 140 may consist of one or more cloud storage devices. The storage 140 may be volatile or non-volatile and may comprise read-only memory (ROM), random-access memory (RAM), ternary content-addressable memory (TCAM), dynamic random-access memory (DRAM), and static random-access memory (SRAM).

The storage 140 stores instructions 138 that, when executed by the processor 130, causes the processor 130 to perform the operations that are described in FIG. 3. The instructions 138 may comprise any suitable set of instructions, logic, rules, or code. The storage 140 may also include storage that takes the form of a database for storing annotated documents 142. The annotated document 142 may be used by the processor 130 when performing the suggester operation 132 as well as when training or using the one or more machine learning models 136. The annotated documents 142 may be stored and recalled using known protocols such as SQL, XML, or any other protocol or language that a user 105, administrator, or developer of the system 100 wishes to use.

The machine learning models 136 may take the form of a LayoutLM Model, a Metatype Model, a Sentence Bert Model, a Neighbors Model, and an Ensemble Model, as will be described in more detail below with regards to FIG. 2 and FIG. 3. The specific type of machine learning models 136 stored in the storage 140 and used by the processor 130 are not limited to those machine learning models and may include other types of models and may take any form, including naïve bayes, linear regression, decision trees, and neural network algorithms such as a feedforward neural network, autoencoder, probabilistic neural network (PNN), convolutional neural network (CNN), or other known machine learning models 136. The specific type of machine learning model 136 stored in the storage 140 and used by the processor 130 may be selected based on a variety of factors, including computational ability of the processor 130, speed of the machine learning models 136, and the appropriateness to type or group of documents the new document 160 belongs to. The machine learning models 136 may be trained based on feedback from the user 105, other users, or administrators each time a new document 160 is analyzed using the suggester operation 132.

### 2.2 Details of a Suggester

FIG. 2 illustrates an embodiment of the suggester operation 132. The suggester operation 132 described in FIG. 2 may be performed by the processor 130 as described in FIG. 1. However, the suggester operation 132 of FIG. 2 may be performed by any component and is not limited to being performed by the processor 130 shown and described in FIG. 1.

The suggester operation 132 utilizes a plurality of annotated documents 210 to train one or more machine learning models and, using these models, is able to annotate a new document. As shown in FIG. 2, when a new document 160 is received, the suggester operation 132 applies a plurality of machine learning models such as, but not limited to, a LayoutLM Model 220, a Metatype Model 222, a Sentence Bert Model 224, and a Neighbor Model 226, which will be described in more detail below. Additionally, an Area Detector operation 230 identifies segments in the new document and its results along with an Ensemble Model 250 that uses the various machine learning models to produce a combined score and bbox, which are combined together to produce a suggested bbox and confidence score as shown in block 240 for the suggested bboxs in the new document 160.

In some embodiments, the processor 130 performing the suggester operation 132 uses a LayoutLM Model 220 for generating a score between annotated documents 210 and a new document 160. LayoutLM Model 220 is responsible for the following tasks: (1) comparing embeddings such as, but not limited to, text embeddings, image descriptors, or any other relevant information that helps characterize the content, for segments found within designated fields of an annotated document 210 against embeddings for segments within the corresponding fields of a new document 160, of which the comparison aims to identify patterns within these corresponding fields of the new document 160; (2) assigning a score to each of the segments within each of these corresponding fields of the new document 160, of which the score of each of the segments is determined based on the similarities observed in their embeddings; (3) aggregating the individual scores of segments within each field to produce a single score for the corresponding field. Therefore, the LayoutLM Model 220 is utilized to analyze and score the similarity of segments within designated fields between annotated documents 210 and a new document 160, ultimately generating an aggregated score for each corresponding field in the new document 160 for determining which field to annotate.

In some embodiments, the processor 130 performing the suggester operation 132 uses a Metatype Model 222 for generating scores by comparing similarities of a specific type of data recognized or categorized within each segment, including but not limited to date, name, numbers, and texts, between the annotated documents 210 and the new document 160, and aggregating the scores.

In some embodiments, the processor 130 performing the suggester operation 132 uses a Sentence Bert Model 224 for generating a score between annotated documents and a new document based on the extracted bounding box (bbox) regions. A bbox region is a rectangular or square-shaped region that is defined by two sets of coordinates: one specifying the position of the top-left corner of the box and the other specifying the position of the bottom-right corner of the box. This rectangular region is used to enclose and define the boundaries of an object or region of interest within an image or a two-dimensional space of a document. Therefore, the Sentence Bert Model 224 is utilized to analyze and score the similarity of segments within designated bbox regions between annotated documents 210 and a new document 160, ultimately generating an aggregated score for each corresponding bbox region in the new document 160 for determining which bbox region to annotate.

Specifically, the Sentence Bert Model 224 is responsible for the following tasks. First, perform a layout analysis on both the annotated documents 210 and the new document 160. Then, extract multiple bbox regions around various elements, such as text, images, tables, and other objects, in both documents. These bounding boxes define the spatial layout of content in each document. Second, identify corresponding bbox regions in the new document 160 by finding similarities within the bbox regions in the annotated documents 210. This step involves finding regions in the new document 160 that closely resemble annotated regions in the reference annotated document. Various techniques may also be used to find closely resemble bbox regions between the annotated documents 210 and the new document 160, including but not limited to comparing the coordinates, sizes, and relative positions of the segments of the bbox regions. Third, identify the corresponding bbox regions for both documents, compare embeddings within each bbox region between the annotated documents 210 and the new document 160, and assign a score to each of the segments within each of these corresponding bbox regions of the new document 160. The Sentence Bert Model 224 may further prioritize a previously processed bbox region in the document to minimize computational resources.

In some embodiments, the processor 130 performing the suggester operation 132 uses a Neighbor Model 226 for comparing embeddings for segments between the extracted bbox regions of the annotated documents and the new document. This component is also responsible for computing a proximity score between neighboring segments in all directions of the annotated documents and identifying anchor words in the extracted bbox regions.

Once the processor 130 performing the suggester operation 132 analyzes the new document 160 using one or more of the LayoutLM Model 220, Metatype Model 222, Sentence Bert Model 224, and Neighbor Model 226, the results of these models are applied to an Ensemble Model 250 for generating a combined score for each segment by weighted averaging all the scores generated by the various machine learning models above to identify candidate segments for predicting annotations of a new document. The Ensemble Model 250 combines the scores and annotation suggestions from the models and applies an appropriate weight to each of the scores based on previous feedback received by the processor 130 from the user 105.

The processor 130, performing the suggester operation 132, may also perform an Area Detector operation 230 for identifying and selecting a coherent subset of segments by removing unqualified positively scored segments to determine the final segments for predicting annotations on a new document 160. The identifying and selecting a coherent subset of segments comprises building a graph based on a heuristic rule, wherein the graph includes nodes representing all scored segments, edges established between nodes based on the heuristic rule of connecting the nodes, and cliques representing sets of nodes of the graph satisfying the rule wherein every node is connected to every other node in one of the cliques. The Area Detector operation 230 further comprises identifying one of the cliques with the highest overall score to output a prediction of a field of the new document 160 representing the predicted annotation suggestions, wherein the output prediction may be assigned a confidence score and filtered based on a threshold to improve the prediction's quality and accuracy.

In some embodiments, the workflow for annotating documents of the present disclosure may further include an asynchronous component (not shown). This component may asynchronously update the suggester operation 132 in a backend process. In some embodiments, the backend process includes storing the training data in a cloud-based database and running all the training in the backend process, where the process further includes a least recently used (LRU) cache algorithm that has a fixed size limit for specifying the maximum number of items it may store while training the machine learning model. The LRU cache algorithm keeps track of the order in which items were accessed or added to the cache. The items that are used more frequently tend to stay in the cache, while items that are not used for a while are more likely to be removed when the cache reaches its size limit. LRU caching for this backend process is used to improve the efficiency of the training by reducing the need to repeatedly access the same data sources.

Returning to FIG. 2, once the Ensemble Model 250 produces one or more suggested bboxs and confidence scores, the results are combined with the results of the Area Detector operation 230 to produce suggested bbox with confidence scores as shown in block 240. When the confidence scores are greater than a predetermined threshold, the processor 130 then annotates the suggested bbox to produce the suggested annotated document 162, which is sent through the network 120 to the external device 110 so that a user 105 may validate or invalidate the suggested annotations to provide validated annotation suggestions and invalidated annotation suggestions. The user 105 may provide other feedback and updated annotations, which are then used along with the validated annotation suggestions and invalidated annotation suggestions for producing an annotated document 164. The resulting annotated document 164 is storied with other documents in the same group of documents in the annotated document 142 of the storage 140. Additionally, the feedback from the user, such as validating a suggestion, invalidating a suggestion, or providing additional or new annotations, is used to train the LayoutLM Model 220, the Metatype Model 222, the Sentence Bert Model 224, Neighbor Model 226, and Ensemble Model 250 used by the suggester operation 132. The specific models shown and described in FIG. 2 are examples, and the disclosure is not limited to these specific machine learning models.

### 2.3 Method of Annotating Documents

A general method of annotating a group of documents is shown in FIG. 3. FIG. 3 is a flowchart of an embodiment of a method 300 for annotating documents, as well as training one or more machine learning models for a specific document type. In some embodiments the method 300, described in FIG. 3 is performed by the processor 130, which executes instructions 138 stored in the storage 140, as shown in FIG. 1. However, method 300 is not limited to being performed by the processor 130, as shown in FIG. 1.

The method 300 starts by receiving a new document 160 at operation 305. In one or more embodiments, the processor 130 receives the new document 160 from the external device 110 or another device associated with a user 105. Alternatively, or additionally the new document 160 may be obtained from a different device connected to the processor 130 through the network 120. Further, the new document 160 may have been previously stored in storage 140.

Once the new document 160 is received in operation 305, the method proceeds to operation 310. In operation 310, the processor 130, performing the suggester operation 132, analyzes the new document 160 to determine similarities between the new document 160 and one or more annotated documents 142 in storage 140 and identifies a group of documents to which the new document 160 is most similar. The processor 130 may determine the group by using a clustering algorithm that compares the new document 160 or parts of the new document 160 with annotated documents 142 in storage 140. This may involve analyzing word location and identifying similar words. This may be done using statistical distributions, hierarchical clustering, k-means algorithms, distribution models such as but not limited to multivariate normal distribution, density models, group models, graph-based models such as the HCS clustering algorithm, one or more trained neural networks, or any other clustering algorithm that is appropriate to the type of documents in the annotated documents 142 or the new document 160, and that may be performed efficiently by the processor 130.

Once the type of document that the new document 160 belongs to is determined in operation 310, the method proceeds to operation 315, where the processor 130 determines if the type of document the new document 160 is most similar to has been received before or is present in the annotated documents 142 in storage 140. If the new document is similar to a document type that has been received before the method proceeds to operation 330, however, if the new document 160 is not similar to a type of document that has been received before the method proceeds to operation 320.

In operation 320, the processor sends a signal and causes the external device 110 to display instructions for the user 105 to annotate the new document 160. Once the user annotates the new document 160 and the annotated document 164 is received by the processor performing the suggester operation 132, the method proceeds to operation 325, where the suggester utilizes the annotated document 164 to train one or more machine learning models. This process (operations 320 and 325) may only be performed with the initial new document 160 of a specific type or may be performed for the first three, five, or ten new documents 160 received that are most similar to a new specific type.

Returning to operation 315, if the type of document has been received before the method, then precedes to operation 330. Where the appropriate trained machine learning models 136 are retrieved from the storage 140. In one or more embodiments, the trained machine learning models 136 take the form of the LayoutLM Model 220, the Metatype Model 222, the Sentence Bert Model 224, Neighbor Model 226, and Ensemble Model 250 described above with regards to FIG. 2. However, the trained machine learning models 136 may take any form appropriate to the type of document without departing from the disclosure.

Once the trained machine learning models 136 are retrieved in operation 330, the method proceeds to operation 335, where the processor 130, performing the suggester operation 132 that uses the trained machine learning models 136, produces predicted annotation suggestions, which are then used to produce a suggested annotated document 162. In one or more embodiments, operation 335 may be performed by the processor 130 using the Ensemble Model 250 to combine the outputs of other trained machine learning model 136 to produce one or more suggested bboxs and confidence scores to produce suggested bbox with confidence scores. When the confidence scores are greater than a predetermined threshold, the processor 130 then annotates the suggested bbox to produce the suggested annotated document 162, which is sent through the network 120 to the external device 110.

In some embodiments, operation 335 may be performed as a backend process, which includes storing the training data in a cloud-based database and running all the training in the backend process where the process further includes a least recently used (LRU) cache algorithm that has a fixed size limit for specifying the maximum number of items it may store while training the machine learning model. The LRU cache algorithm keeps track of the order in which items were accessed or added to the cache. The items that are used more frequently tend to stay in the cache, while items that are not used for a while are more likely to be removed when the cache reaches its size limit. LRU caching for this backend process is used to improve the efficiency of the training by reducing the need to repeatedly access the same data sources.

Once the processor 130 performing the suggester operation 132 produces predicted annotation suggestions in operation 335, the method proceeds to operation 340. In operation 340, the processor 130 causes the external device 110 or other device associated with a user 105 to display the suggested annotated document 162 produced in operation 335. The user 105 in operation 345 may then apply one or more corrections to the suggested annotated document. For example, in a non-limiting example, the user 105 may invalidate a suggestion where a section of the new document 160 does not need to be annotated, or the user may move the annotation to the correct position, as will be described in more detail below with regards to the example shown in FIG. 4. Further a user 105 may indicate that a suggested annotation produced in operation 335 is correct or valid. Once the user has corrected the suggested annotated document 162 in operation 345, the correctly annotated document 164 is sent back through the network 120 to the processor 130 and is stored in the storage 140 with the other annotated documents 142. Alternatively, or additionally, the annotated document 164 is forwarded to one or more other processes or applications for use.

Once corrections are made by a user 105 in operation 345, the method proceeds to operation 350, where the processor 130 determines if any corrections or feedback was received from the user 105. If corrections or feedback is received, the method returns to operation 325, where the trained machine learning models 136 are updated using the user annotations and feedback. Otherwise, if there are no corrections in operation 350, the method proceeds to operation 355.

In operation 355 the processor 130 determines if there are any additional new documents 160. If there are additional new documents, the method proceeds to operation 305, and operations 305-355 are repeated until no additional new documents require processing. The method may then end after operation 355.

### 2.4 Example Annotated Document

FIG. 4 shows an exemplary document produced or utilized by the processor 130 performing the suggester operation 132 as described above in FIG. 1, FIG. 2, and FIG. 3. A new document 160 is received from the external device 110 and forwarded to the processor 130, which performs the suggester operation 132 on the new document 160. When the new document 160 is received by the processor 130, the processor 130, in the example shown in FIG. 4, indicates four fields of annotation suggestions, which are surrounded by squares, in the example of a suggested annotated document 410. These fields of suggestion from the suggested annotated document 410 are sent to the external device 110 to be verified and edited by the user 105.

One or more users 105 or another process provide corrections 420. In the example of 420, the user 105 changes one of the examples from one location or field to another, and these corrections 420 are sent back to the processor 130 as an annotated document 164. Once the corrections 420 are received by the processor 130, a final annotated document 430 is created and used for any additional processes and stored in the storage 140 as an annotated document 142. The correction 420 is then automatically used as feedback for the suggester operation 132 and used for training the one or more machine learning models 136.

### 3. Implementation Example-Hardware Overview

According to one embodiment, the techniques described herein are implemented by at least one computing device. The techniques may be implemented in whole or in part using a combination of at least one server computer or other computing devices that are coupled using a network, such as a packet data network. The computing devices may be hard-wired to perform the techniques or may include digital electronic devices such as at least one application-specific integrated circuit (ASIC) or field-programmable gate array (FPGA) that is persistently programmed to perform the techniques or may include at least one general-purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired or program logic to implement the described techniques, one or more virtual computing machines or instances in a data center, or a network of server computers or personal computers.

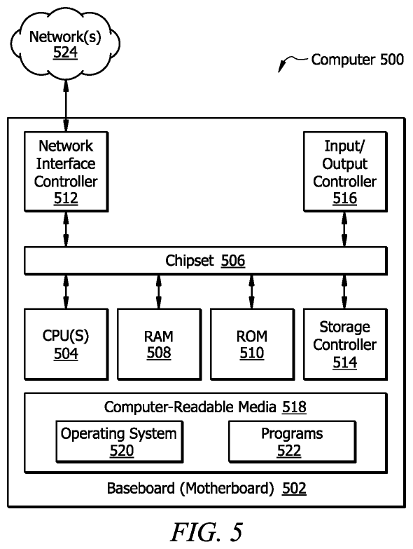

FIG. 5 is a block diagram showing an example of computer architecture for a device capable of executing program components for implementing the abovementioned functionality. The computer architecture shown in FIG. 5 illustrates any type of computer 500, such as a conventional server computer, workstation, desktop computer, laptop, tablet, network appliance, e-reader, smartphone, or other computing device, and may be utilized to execute any of the software components presented herein. The computer 500 may, in some examples, correspond to the processor, e.g., 130, FIG. 1, or any other device, including the external device e.g., 110, FIG. 1, described herein, and may comprise personal devices (e.g., smartphones, tablets, wearable devices, laptop devices) networked devices such as servers, switches, routers, hubs, bridges, gateways, modems, repeaters, access points, or any other type of computing device that may be running any type of software or virtualization technology.

The computer 500 includes a baseboard 502, or “motherboard,” which is a printed circuit board to which a multitude of components or devices may be connected by way of a system bus or other electrical communication paths. In one illustrative configuration, one or more central processing units (“CPUs”) 504 operate in conjunction with a chipset 506. The CPUs 504 may be standard programmable processors that perform arithmetic and logical operations necessary for the operation of the computer 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the state of one or more other switching elements, such as a logic gateway. These basic switching elements may be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 may provide an interface to a RAM 508, which is used as the main memory in the computer 500. The chipset 506 may further provide an interface to a computer-readable storage medium such as a read-only memory (“ROM”) 510 or non-volatile RAM (“NVRAM”) for storing basic routines that help to startup the computer 500 and to transfer information between the various components and devices. The ROM 510 or NVRAM may also store other software components necessary for the operation of the computer 500 in accordance with the configurations described herein.

The computer 500 may operate in a networked environment using a logical connection to remote computing devices and computer systems through a network, such as the network 120 shown in FIG. 1. The chipset 506 may include functionality for providing network connectivity through a Network Interface (NIC) 512, such as a gigabit Ethernet adapter. The NIC 512 may connect the computer 500 to other computing devices over the network 524. It should be appreciated that multiple NICs 512 may be present in the computer 500, connecting the computer to other types of networks and remote computer systems.

The computer 500 may be connected to a computer-readable media 518 or other form of storage device that provides non-volatile storage for the computer 500. The computer-readable media 518 may store an operating system 520, programs 522, and other data. The computer-readable media 518 may be connected to the computer 500 through a storage controller 514 connected to the chipset 506. The computer-readable media 518 may consist of one or more physical storage units. The storage controller 514 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 500 may store data on the computer-readable media 518 by transforming the physical state of the physical storage units to reflect the information being stored. The specific transformation of the physical state may depend on various factors in different embodiments of this description. Examples of such factors may include, but are not limited to, the technology used to implement the physical storage units, whether the storage device is characterized as primary or secondary storage, and the like.

For example, the computer 500 may store information to the computer-readable media 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete components in a solid-state storage unit. Other transformations of physical media are possible without departing from the scope and spirit of the present description, with the foregoing examples provided only to facilitate this description. The computer 500 may further read information from the computer-readable media 518 by detecting the physical states or characteristics of one or more locations within the physical storage units.

In addition to the computer-readable media 518 described above, the computer 500 may have access to other computer-readable storage media to store and retrieve information, such as program modules, data structures, or other data. It should be appreciated by those skilled in the art that computer-readable storage media is any available media that provides for the non-transitory storage of data and that may be accessed by the computer 500. In some examples, the operations performed by the processor, e.g., 130, FIG. 1, external device, e.g., 110, FIG. 1, or any components included therein may be supported by one or more devices similar to computer 500. Stated otherwise, some or all of the operations performed by the API gateway or any components included therein may be performed by one or more computers 500.

By way of example and not limitation, computer-readable storage media may include volatile and non-volatile, removable, and non-removable media implemented in a method or technology. Computer-readable storage media includes but is not limited to RAM, ROM, erasable programmable ROM (“EPROM”), electrically-erasable programmable ROM (“EEPROM”), flash memory or other solid-state memory technology compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned briefly above, the computer-readable media 518 may store an operating system 520 utilized to control the operation of the computer 500. The computer-readable media 518 may store other system or application programs and data utilized by the computer 500. In one embodiment, the computer-readable media 518 or other computer-readable storage media is encoded with computer-executable instructions which, when loaded into the computer 500, transform the computer from a general-purpose computing system into a special-purpose computer capable of implementing the embodiments described herein. These computer-executable instructions transform the computer 500 by specifying how the CPUs 504 transition between states, as described above. According to one embodiment, the computer 500 has access to computer-readable storage media storing computer-executable instructions, which, when executed by the computer 500, perform the various operations described above with regards to FIG. 3. The computer 500 may also include computer-readable storage media having instructions stored thereupon for performing any of the other computer-implemented operations described herein.

The computer 500 may also include one or more input/output controllers 516 for receiving and processing input from several input devices, such as a keyboard, a mouse, a touchpad, a touch screen, an electronic stylus, or another type of input device. Similarly, an input/output controller 516 may provide output to a display such as a computer monitor, a flat panel display, smartphone display, a digital projector, a printer, or another type of output device. It will be appreciated that the computer 500 might not include all of the components shown in FIG. 1 and FIG. 2. Computer 500 may include other components that are not explicitly shown in FIG. 1 and FIG. 2, or might utilize an architecture completely different than that shown in FIG. 1-2.

The computer 500 may include one or more hardware processors 504 (CPUs) configured to execute one or more stored instructions. The processor(s) 504 may comprise one or more cores. Further, the computer 500 may include one or more network interfaces 512 configured to provide communications between the computer 500 and other devices, such as the communications described herein as being performed by the processor, e.g., 130 FIG. 1. The network interface 512 may include devices configured to couple to personal area networks (PANS), wired and wireless local area networks (LANS), wired and wireless wide area networks (WANs), and so forth. For example, the network interfaces may include devices compatible with Ethernet, WI-FI™, and so forth.

The programs 522 may comprise any type of programs or processes to perform the techniques described in this disclosure for annotating documents.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated into another system, or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed:

1. A method for annotating documents, comprising:
receiving from an external device a new document;
analyzing the new document to determine a group of documents from a plurality of document groups that the new document is most similar to;
retrieving one or more trained machine learning models that have been trained on previous documents associated with the group of documents;
analyzing the new document utilizing the one or more trained machine learning models;
producing one or more annotation suggestions based on the analyzing;
presenting to a user the one or more annotation suggestions;
receiving from the user one or more corrections to the one or more annotation suggestions;
annotating the new document with the one or more corrections; and
updating the one or more trained machine learning models using the one or more corrections.

2. The method of claim 1, further comprising:
receiving from the user at least one validation for the one or more annotation suggestions; and
annotating the new document with the at least one validated annotation suggestion.

3. The method of claim 1, further comprising:
annotating the new document by the user to produce user annotations when the new document is not similar to a group of documents; and
using the user annotations and the new document to train one or more machine learning models associated with the new document.

4. The method of claim 1, wherein the analyzing the new documents to determine a group of documents is performed using a clustering algorithm that compares the new document to a group of documents in a storage by determining a similarity of the new document to the group of documents by analyzing word location.

5. The method of claim 1, wherein the one or more trained machine learning models comprises of a plurality of trained machine learning models that are applied in multiple steps to determine segments for the new document and provide suggestions for annotating the segments.

6. The method of claim 5, wherein the plurality of trained machine learning models comprises of two or more of a LayoutLM Model, a Metatype Model, a Sentence Bert Model, a Neighbors Model, and an Ensemble Model.

7. The method of claim 1, wherein the one or more trained machine learning models comprises of a plurality of trained machine learning models that each generate segments and a corresponding score, wherein the score generated from each of the trained machine learning models is used to determine the annotation suggestions.

8. A system for annotating documents, comprising:
a storage for storing:
one or more trained machine learning models that have been trained on previous documents associated with a group of documents; and
a processor operably coupled to the storage and configured to:
receive from an external device a new document;
analyze the new document to determine the group of documents from a plurality of document groups that the new document is most similar to;
retrieve the one or more trained machine learning models from the storage;
analyze the new document utilizing the one or more trained machine learning models;
produce one or more annotation suggestions based on the analyzing;
present to a user the one or more annotation suggestions;
receive from the user one or more corrections to the one or more annotation suggestions;
annotate the new document with the one or more corrections; and
update the one or more trained machine learning models using the one or more corrections.

9. The system of claim 8, further comprising:
wherein the processor receives from the user at least one validation for the one or more annotation suggestions; and
the processor annotates the new document with the at least one validated annotation suggestion.

10. The system of claim 8, further comprising:
wherein the processor sends a request to the user for user annotations when the new document is not similar to a group of documents; and
the processor receives the user annotations and uses the user annotations and the new document to train the one or more machine learning models associated with the new document.

11. The system of claim 8, wherein the analyzing the new documents to determine a group of documents is performed using a clustering algorithm that compares the new document to a group of documents in a storage by determining a similarity of the new document to the group of documents by analyzing word location.

12. The system of claim 8, wherein the one or more trained machine learning models comprises of a plurality of trained machine learning models that are applied in multiple steps, to determine segments for the new document and provide suggestions for annotating the segments.

13. The system of claim 12, wherein the plurality of trained machine learning models comprises of two or more of a LayoutLM Model, a Metatype Model, a Sentence Bert Model, a Neighbors Model, and an Ensemble Model.

14. A non-transitory computer-readable medium storing instructions that when executed by a processor cause the processor to:
receive from an external device a new document;
analyze the new document to determine a group of documents from a plurality of document groups that the new document is most similar to;
retrieve one or more trained machine learning models from a storage;
analyze the new document utilizing the one or more trained machine learning models;
produce one or more annotation suggestions based on the analyzing;
present to a user the one or more annotation suggestions;
receive from the user one or more corrections to the one or more annotation suggestions;
annotate the new document with the one or more corrections; and
update the one or more trained machine learning models using the one or more corrections.

15. The non-transitory computer-readable medium of claim 14, further comprising:
wherein the processor receives from the user at least one validation for the one or more annotation suggestions; and
the instructions cause the processor to annotate the new document with the at least one validated annotation suggestion.

16. The non-transitory computer-readable medium of claim 14, further comprising:
wherein the instructions cause the processor to send a request to the user for user annotations when the new document is not similar to a group of documents; and
the instructions cause the processor to receive the user annotations and use the user annotations and the new document to train the one or more machine learning models associated with the new document.

17. The non-transitory computer-readable medium of claim 14, wherein the analyzing the new documents to determine a group of documents is performed using a clustering algorithm that compares the new document to a group of documents in a storage by determining a similarity of the new document to the group of documents by analyzing word location.

18. The non-transitory computer-readable medium of claim 14, wherein the one or more trained machine learning models comprises of a plurality of trained machine learning models that are applied in multiple steps, to determine segments for the new document and provide suggestions for annotating the segments.

19. The non-transitory computer-readable medium of claim 18, wherein the plurality of trained machine learning models comprises of two or more of a LayoutLM Model, a Metatype Model, a Sentence Bert Model, a Neighbors Model, and an Ensemble Model.

20. The non-transitory computer-readable medium of claim 14, wherein the one or more trained machine learning models comprises of a plurality of trained machine learning models that each generate segments and a corresponding score, wherein the score generated from each of the trained machine learning models is used to determine the annotation suggestions.
